(19) United States
(12) Patent Application Publication
(10) Pub. No.: US 2018/0186002 A1
(43) Pub. Date: Jul. 5, 2018

(54) ROBOT, ROBOT CONTROL METHOD, AND PROGRAM

(71) Applicants: SHARP KABUSHIKI KAISHA, Sakai City, Osaka (JP); ROBO GARAGE CO., LTD., Otsu-shi, Shiga (JP)

(72) Inventors: TAKAHIRO INOUE, Sakai City (JP); AKIRA MOTOMURA, Sakai City (JP); TOMOTAKA TAKAHASHI, Otsu-shi (JP)

(21) Appl. No.: 15/740,185

(22) PCT Filed: Jul. 8, 2016
(86) PCT No.: PCT/JP2016/070328

§ 371 Date: Dec. 27, 2017

(30) Foreign Application Priority Data
Sep. 28, 2015 (JP) 2015-190120

(51) Int. Cl. B25J 9/16; B25J 9/00; G06N 3/00

(52) U.S. Cl. CPC B25J 9/1664; B25J 9/0087; Y10S 901/02; G06N 3/008; B25J 9/1669

(57) ABSTRACT

Provision of a robot which has a simpler configuration and is capable of a stand-up operation. A posture controlling section (10) changes a posture of a robot 1 from a sitting posture to a bridge posture. In the bridge posture, a projected point (T), which represents a center of gravity of the robot (1) projected onto a plane parallel to a support polygon (R) of the robot (1), is at a position that is outside the support polygon (R) and near a right leg part 6 and a left leg part 7.

### TECHNICAL FIELD

The present invention relates to (i) a robot capable of a stand-up operation, (ii) a method of controlling a robot, and a program.

### BACKGROUND ART

To date, a variety of robots capable of a stand-up operation have been proposed. Examples of such robots are disclosed in Patent Literatures 1 to 3. Patent Literatures 1 to 3 disclose examples of a robot which, when in a supine posture, carries out a stand-up operation while causing a zero moment point (ZMP) of the robot to move toward soles of the robot's feet.

### CITATION LIST

### Patent Literature

[Patent Literature 1]

Japanese Patent Application Publication, Tokukai, No. 2001-150370 (Publication Date: Jun. 5, 2001)

[Patent Literature 2]

Japanese Patent Application Publication, Tokukai, No. 2004-249374 (Publication Date: Sep. 9, 2004)

[Patent Literature 3]

Japanese Patent Application Publication, Tokukai, No. 2004-106185 (Publication Date: Apr. 8, 2004)

### SUMMARY OF INVENTION

### Technical Problem

With the robots disclosed in Patent Literatures 1 to 3, in a case where, for example, a leg part of the robot has a narrow range of movement (for example, if hip joints have a narrow range of movement, or if the robot does not have hip joints), or arms of the robot are short, the robot cannot move its ZMP toward the soles of the robot's feet. Robots having this sort of simple configuration therefore have a problem of not being able to carry out a stand-up operation.

The present invention has been made in view of the above problem. An object of the present invention is to provide (i) a robot which has a simpler configuration and is capable of a stand-up operation, (ii) a method of controlling the robot, and (iii) a program.

### Solution to Problem

In order to solve the above problem, a robot in accordance with an embodiment of the present invention includes at least: a head part; a trunk part; arm parts; leg parts; and a posture controlling section configured to change a posture of the robot from a first posture to a second posture, the first posture being a posture in which (i) respective front portions of at least the leg parts face vertically upward and (ii) a projected point, which represents a center of gravity of the robot projected onto a plane parallel to a support polygon of the robot, falls inside the support polygon, the second posture being a posture in which the projected point is at a position that is outside the support polygon and near each of the leg parts.

### Advantageous Effects of Invention

An aspect of the present invention makes it possible to provide a robot which has a simpler configuration and is capable of a stand-up operation.

### BRIEF DESCRIPTION OF DRAWINGS

FIG. 1 is a block diagram illustrating an external configuration of a robot in accordance with an embodiment of the present invention.

FIG. 2 is a diagram illustrating an internal configuration of a robot in accordance with an embodiment of the present invention.

FIG. 3 is a diagram for explaining respective rotation directions of a neck roll section, a neck pitch section, and a neck yaw section in an embodiment of the present invention.

FIG. 4 is a diagram illustrating a robot in accordance with an embodiment of the present invention in a supine posture and the robot in an upright posture.

FIG. 5 is a diagram illustrating various postures taken on by a robot in accordance with an embodiment of the present invention as the robot changes its posture from a sitting posture to a bridge posture.

FIG. 6 is a diagram illustrating various postures taken on by a robot in accordance with an embodiment of the present invention as the robot changes its posture from a bridge posture to a prone posture.

### DESCRIPTION OF EMBODIMENTS

### Embodiment 1

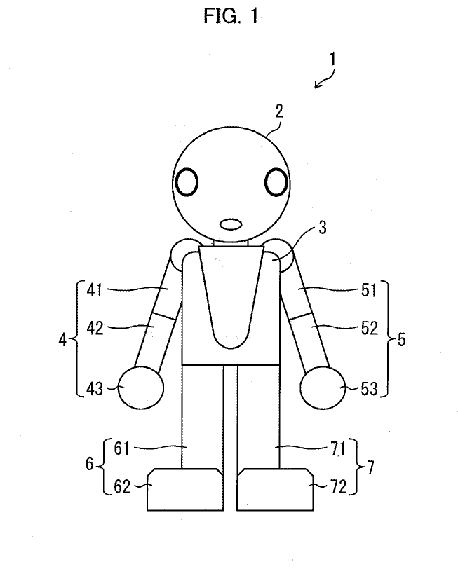

The following description will discuss Embodiment 1 of the present invention with reference to FIGS. 1 to 6.

### Overview of Robot 1

A robot 1 in accordance with Embodiment 1 is a so-called “humanoid” robot 1 which has at least a head part 2, a trunk part 3, two arm parts (a right arm part 4 and a left arm part 5), and two leg parts (a right leg part 6 and a left leg part 7). By executing a novel method of posture control, the robot 1 can change its posture from a sitting posture to a bridge posture and then to a prone posture, from which the robot 1 ultimately stands up.

### External Configuration of Robot 1

FIG. 1 is a block diagram illustrating an external configuration of the robot 1 in accordance with Embodiment 1. As illustrated in FIG. 1, the robot 1 includes the head part 2, the trunk part 3, the right arm part 4 (arm part), the left arm part 5 (arm part), the right leg part 6 (leg part), and the left leg part 7 (leg part). FIG. 1 illustrates the robot 1 as viewed from the front of the robot 1.

The right arm part 4 includes a right upper arm part 41, a right forearm part 42, and a right hand part 43. The right upper arm part 41, the right forearm part 42, and the right hand part 43 are provided in this order, from a first end (on a shoulder side) of the right arm part 4 to a second end (on a distal side) of the right arm part 4. The first end of the right arm part 4 is connected to the trunk part 3 at a position corresponding to a right shoulder side. The left arm part 5 includes a left upper arm part 51, a left forearm part 52, and a left hand part 53. The left upper arm part 51, the left forearm part 52, and the left hand part 53 are provided in this order, from a first end (on a shoulder side) of the left arm part 5 to a second end (on a distal side) of the left arm part 5. The first end of the left arm part 5 is connected to the trunk part 3 at a position corresponding to a left shoulder side.

The right leg part 6 includes a right thigh part 61 and a right foot part 62. A first end (on a hip side) of the right thigh part 61 is connected to the trunk part 3 at a position corresponding to a pelvis side. A second end (on a distal side) of the right thigh part 61 is connected to the right foot part 62. The left leg part 7 includes a left thigh part 71 and a left foot part 72. A first end (on a hip side) of the left thigh part 71 is connected to the trunk part 3 at a position corresponding to a pelvis side. A second end (on a distal side) of the left upper arm part 51 is connected to the left foot part 72.

### Internal Configuration of Robot 1

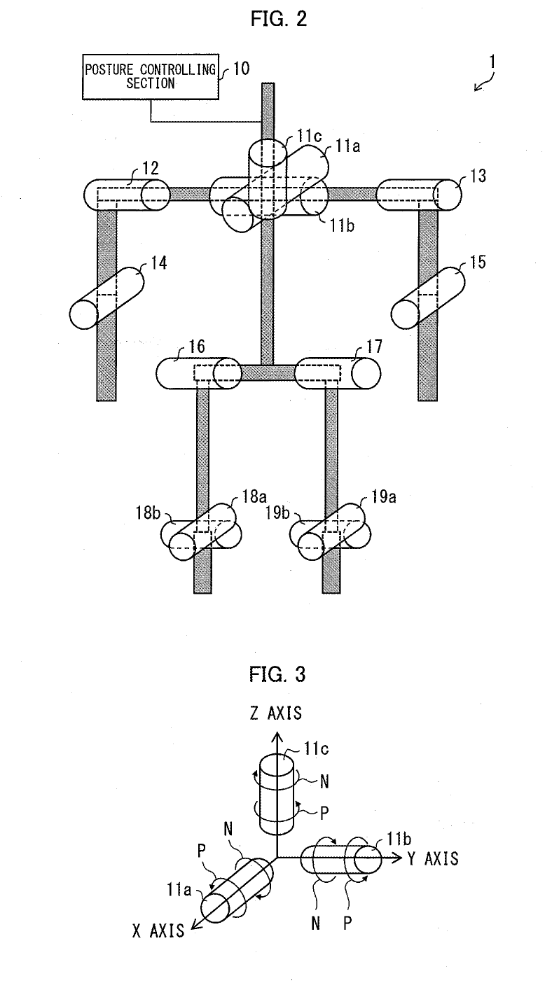

FIG. 2 is a diagram illustrating an internal configuration of the robot 1 in accordance with Embodiment 1. As illustrated in FIG. 2, in addition to the various members illustrated in FIG. 1, the robot 1 further includes a posture controlling section 10, a neck roll section 11a, a neck pitch section 11b, a neck yaw section 11c, a right shoulder pitch section 12, a left shoulder pitch section 13, a right elbow roll section 14, a left elbow roll section 15, a right hip joint pitch section 16, a left hip joint pitch section 17, a right ankle roll section 18a, a right ankle pitch section 18b, a left ankle roll section 19a, and a left ankle pitch section 19b. In Embodiment 1, each of the sections listed above, from the neck roll section 11 a to the left ankle roll section 19a, is a servomotor.

The posture controlling section 10 is connected to internal members of the robot 1, such as the neck roll section 11a. The posture controlling section 10 controls the posture of the robot 1 by outputting predetermined control signals so as to control movement of the neck roll section 11a and the like.

The neck roll section 11a, the neck pitch section 11b, and the neck yaw section 11c are each provided at a position which corresponds to a neck of the robot 1. The posture controlling section 10 can control movement of the head part 2 of the robot 1 by controlling these sections.

The right shoulder pitch section 12 is provided at a position which corresponds to a right shoulder of the robot 1. The posture controlling section 10 can control movement of the entirety of the right arm part 4 of the robot 1 by controlling the right shoulder pitch section 12. The left shoulder pitch section 13 is provided at a position which corresponds to a left shoulder of the robot 1. The posture controlling section 10 can control movement of the entirety of the left arm part 5 of the robot 1 by controlling the left shoulder pitch section 13.

The right elbow roll section 14 is provided at a position which corresponds to a right elbow of the robot 1. The posture controlling section 10 can control movement of the right forearm part 42 and the right hand part 43 of the robot 1 by controlling the right elbow roll section 14. The left elbow roll section 15 is provided at a position which corresponds to a left elbow of the robot 1. The posture controlling section 10 can control movement of the left forearm part 52 and the left hand part 53 of the robot 1 by controlling the left elbow roll section 15.

The right hip joint pitch section 16 is provided at a position which corresponds to a right hip joint of the robot 1. The posture controlling section 10 can control movement of the entirety of the right leg part 6 of the robot 1 by controlling the right hip joint pitch section 16. The left hip joint pitch section 17 is provided at a position which corresponds to a left hip joint of the robot 1. The posture controlling section 10 can control movement of the entirety of the left leg part 7of the robot 1 by controlling the left hip joint pitch section 17.

The right ankle pitch section 18b and the right ankle roll section 18a are each provided at a position which corresponds to a right ankle of the robot 1. The posture controlling section 10 can control movement of the right foot part 62 of the robot 1 by controlling these sections. The left ankle pitch section 19b and the left ankle roll section 19a are each provided at a position which corresponds to a left ankle of the robot 1. The posture controlling section 10 can control movement of the left foot part 72 of the robot 1 by controlling these sections.

### Rotation Axes of Servomotors

FIG. 3 is a diagram for explaining respective rotation directions of the neck roll section 11a, the neck pitch section 11b, and the neck yaw section 11c in Embodiment 1. As illustrated in FIG. 3, three differing axes (an X axis, a Y axis, and a Z axis) are defined for the robot 1. Each of these axes extends in a respective one of three directions which are orthogonal to each other in three-dimensional space. The X axis extends in a direction from a rear side of the robot 1 to a front side of the robot 1. The Y axis extends in a direction from a right side of the robot 1 to a left side of the robot 1. The Z axis extends in a direction from (i) the right foot part 62 and the left foot part 72 of the robot 1 toward (ii) the trunk part 3 of the robot 1.

As illustrated in FIG. 3, the neck roll section 11a, the neck pitch section 11b, and the neck yaw section 11c are aligned along the X axis, the Y axis, and the Z axis, respectively, and each rotate around their respective corresponding axes. Leftward rotation around each of the X axis, the Y axis, and the Z axis is referred to here as a positive direction P of the servomotors, whereas rightward rotation around each of the axes is referred to here as a negative direction N of the servomotors. Each of the servomotors, from the neck roll section 11a to the left ankle pitch section 19b, moves a respective part to be controlled, such as the head part 2, by rotating in the positive direction P or the negative direction N.

The right elbow roll section 14, the left elbow roll section 15, the right ankle roll section 18a, and the left ankle roll section 19a are each aligned along the X axis and rotate around the X axis, similarly to the neck roll section 11a. The right shoulder pitch section 12, the left shoulder pitch section 13, the right hip joint pitch section 16, the left hip joint pitch section 17, the right ankle pitch section 18b, and the left ankle pitch section 19b are each aligned along the Y axis and rotate around the Y axis, similarly to the neck pitch section lib.

### Flow of Stand-Up Operation

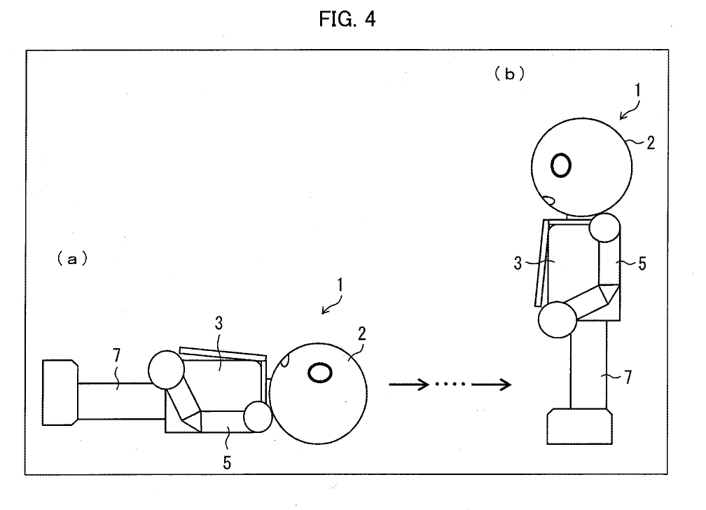

FIG. 4 is a diagram illustrating the robot 1 in accordance with Embodiment 1 in a prone posture and the robot 1 in an upright posture. In Embodiment 1, the robot 1 changes its posture from the prone posture as illustrated in (a) of FIG. 4 to the upright posture as illustrated in (b) of FIG. 4 by carrying out a predetermined stand-up operation. During this stand-up operation, the robot 1 first changes its posture from the prone posture to a sitting posture (a first posture). The robot 1 then changes its posture from the sitting posture to a bridge posture (a second posture). Finally, the robot 1 changes its posture from the bridge posture to the upright posture.

### Posture Change to Sitting Posture

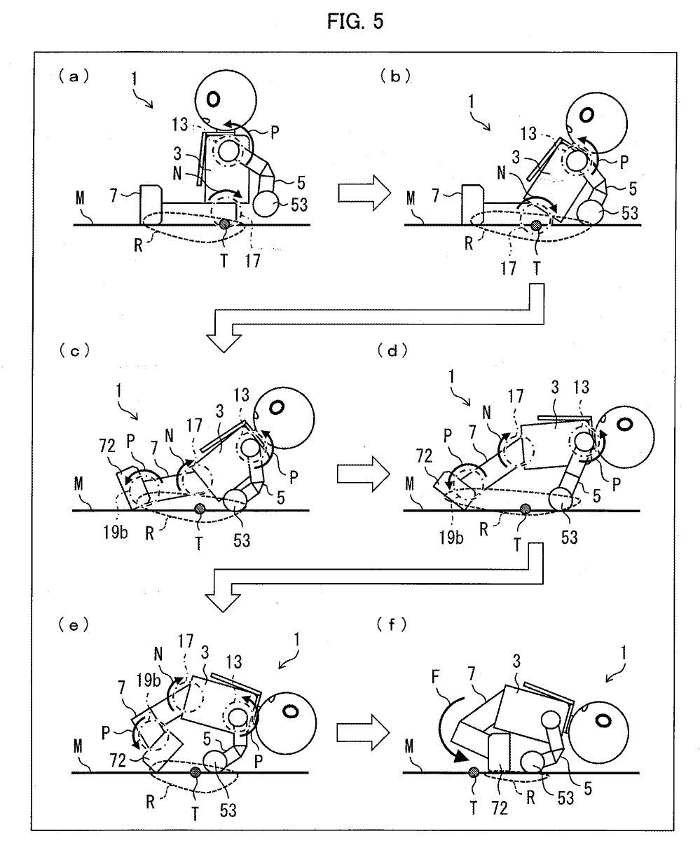

FIG. 5 is a diagram illustrating various postures taken on by the robot 1 in accordance with Embodiment 1 as the robot 1 changes its posture from the sitting posture to the bridge posture. The robot 1 first changes its posture from the supine posture illustrated in (a) of FIG. 4 to the sitting posture shown in (a) of FIG. 5. The posture control carried out by the robot 1 during this change is commonly used, and as such a detailed description of such is omitted here. Note that, here, the sitting posture refers to a posture in which the robot 1 is seated on a ground plane M.

### Posture Change to Bridge Posture

When the robot 1 is in the sitting posture as illustrated in (a) of FIG. 5, both of the arm parts (the right arm part 4 and the left arm part 5) are in a state of non-contact with the ground plane M, whereas both of the leg parts (the right leg part 6 and the left leg part 7) are in contact with the ground plane M. As such, a support polygon R of the robot 1 is formed by both of the leg parts (the right leg part 6 and the left leg part 7). In (a) of FIG. 5, respective front portions of the leg parts (the right leg part 6 and the left leg part 7) are facing vertically upward. Furthermore, a projected point T, which represents a center of gravity of the robot 1 projected onto a plane parallel to the support polygon R, is inside the support polygon R. Note that, here, “projected point T” can refer to either of (i) a point representing a static center of gravity of the robot 1 projected onto a plane and (ii) a point representing a dynamic center of gravity of the robot 1 projected onto a plane.

When the robot 1 is in the sitting posture, the posture controlling section 10 causes both of the shoulder pitch sections (the right shoulder pitch section 12 and the left shoulder pitch section 13) to rotate in the positive direction P. This moves both of the arm parts (the right arm part 4 and the left arm part 5) toward a region rearward of the trunk part 3 such that both of the hand parts (the right hand part 43 and the left hand part 53) move away from the rear of the trunk part 3. Furthermore, the posture controlling section 10 causes both of the hip joint pitch sections (the right hip joint pitch section 16 and the left hip joint pitch section 17) to rotate in the negative direction N. This causes the head part 2, the trunk part 3, and both of the arm parts (the right arm part 4 and the left arm part 5) to lean toward a region rearward of the robot 1. As a result, both of the hand parts (the right hand part 43 and the left hand part 53) come into contact with the ground plane M, and the posture of the robot 1 changes to the posture illustrated in (b) of FIG. 5. When the robot 1 is in this posture, the support polygon R is formed by both of the hand parts (the right hand part 43 and the left hand part 53) and both of the leg parts (the right leg part 6 and the left leg part 7), each of which is in contact with the ground plane M.

Once the robot 1 is in the posture illustrated in (b) of FIG. 5, the posture controlling section 10 causes both of the shoulder pitch sections (the right shoulder pitch section 12 and the left shoulder pitch section 13) to further rotate in the positive direction P and causes both of the hip joint pitch sections (the right hip joint pitch section 16 and the left hip joint pitch section 17) to further rotate in the negative direction N. By doing so, the posture controlling section 10 causes a pelvis part of the robot 1 to lift up from the ground plane M. As a result, the posture of the robot 1 changes to the posture illustrated in (c) of FIG. 5. When the robot 1 is in this posture, both of the hand parts (the right hand part 43 and the left hand part 53) and both of the foot parts (the right foot part 62 and the left foot part 72) support the trunk part 3, while the pelvis part of the robot 1 is in a state of non-contact with the ground plane M.

Once the robot 1 is in the posture illustrated in (c) of FIG. 5, the posture controlling section 10 causes both of the shoulder pitch sections (the right shoulder pitch section 12 and the left shoulder pitch section 13) to further rotate in the positive direction P and causes both of the hip joint pitch sections (the right hip joint pitch section 16 and the left hip joint pitch section 17) to further rotate in the negative direction N. By doing so, the posture controlling section 10 causes the pelvis part of the robot 1 to lift up even higher from the ground plane M. The posture controlling section 10 also causes both of the ankle pitch sections (the right ankle pitch section 19a and the left ankle pitch section 19b) to rotate in the positive direction P so as to cause both of the foot parts (the right foot part 62 and the left foot part 72) to move. This causes undersides of both of the foot parts (the right foot part 62 and the left foot part 72) to be in contact with the ground plane M. As a result, the posture of the robot 1 changes from the posture illustrated in (c) of FIG. 5 to the posture illustrated in (d) of FIG. 5.

Once the robot 1 is in the posture illustrated in (d) of FIG. 5, the posture controlling section 10 causes both of the shoulder pitch sections (the right shoulder pitch section 12 and the left shoulder pitch section 13) to further rotate in the positive direction P. This maintains the balance of the robot 1 as a whole. In other words, the robot 1 takes on a stable posture without falling over. At the same time, the posture controlling section 10 causes both of the hip joint pitch sections (the right hip joint pitch section 16 and the left hip joint pitch section 17) to rotate in the negative direction N and causes both of the ankle pitch sections (the right ankle pitch section 19a and the left ankle pitch section 19b) to rotate in the positive direction P. By doing so, the posture controlling section 10 causes both of the foot parts (the right foot part 62 and the left foot part 72) to move toward the arm parts (the right arm part 4 and the left arm part 5) while maintaining contact between (i) both of the foot parts and (ii) the ground plane M. As a result, the posture of the robot 1 changes to the posture illustrated in (e) of FIG. 5.

Once the robot 1 is in the posture illustrated in (e) of FIG. 5, the posture controlling section 10 causes both of the shoulder pitch sections (the right shoulder pitch section 12 and the left shoulder pitch section 13) and both of the ankle pitch sections (the right ankle pitch section 19a and the left ankle pitch section 19b) to further rotate in the positive direction P and causes both of the hip joint pitch sections (the right hip joint pitch section 16 and the left hip joint pitch section 17) to further rotate in the negative direction N. By doing so, the posture controlling section 10 causes both of the foot parts (the right foot part 62 and the left foot part 72) to move behind the trunk part 3 toward the arm parts (the right arm part 4 and the left arm part 5) while both of the foot parts remain in contact with the ground plane M. As a result, the posture of the robot 1 changes to the bridge posture (second posture) illustrated in (f) of FIG. 5. Because both of the foot parts (the right foot part 62 and the left foot part 72) move while remaining in contact with the ground plane M, it is possible for the robot 1 to maintain stability while changing its posture to the bridge posture illustrated in (f) of FIG. 5.

When the robot 1 is in the bridge posture illustrated in (f) of FIG. 5, the front of the trunk part 3 and the front of the head part 2 face vertically upward. Furthermore, the projected point. T of the center of gravity of the robot 1 is at a position that is outside the support polygon R and near each of the leg parts (the right leg part 6 and the left leg part 7). As such, as illustrated in (f) of FIG. 5, a force F (a force for causing the robot 1 to fall toward a region in front of the robot 1) acts on the robot 1 so as to cause the robot 1 to fall toward the leg parts (the right leg part 6 and the left leg part 7).

### Posture Change to Prone Posture

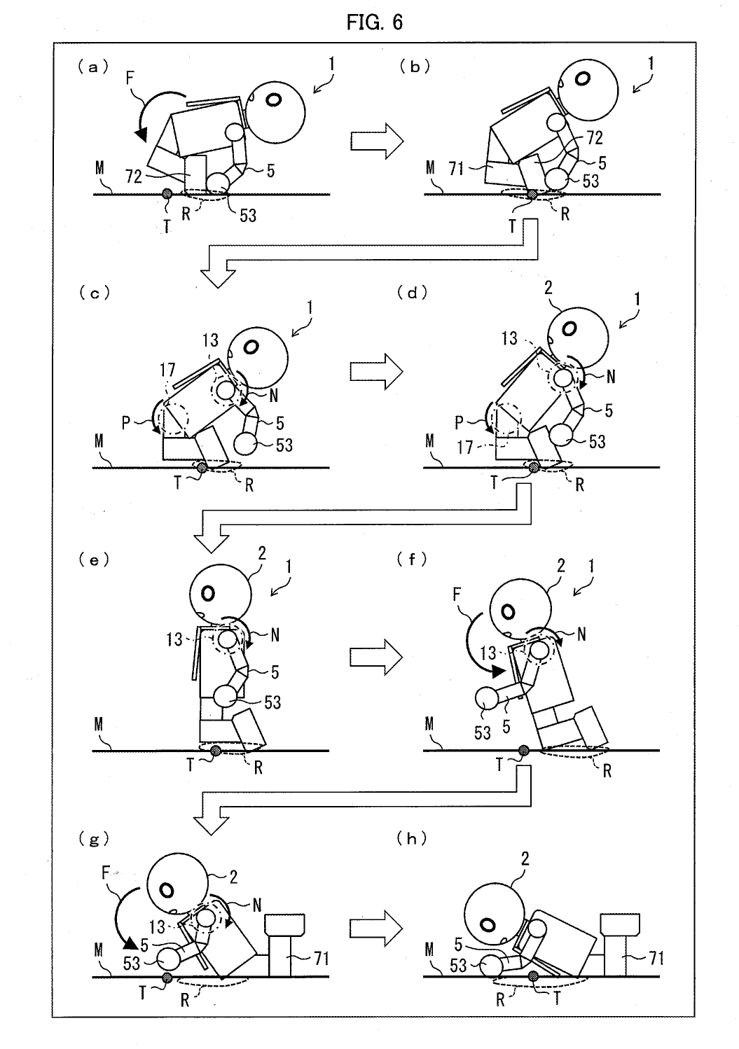

FIG. 6 is a diagram illustrating various postures taken on by the robot 1 in accordance with Embodiment 1 as the robot 1 changes its posture from the bridge posture to the prone posture. When the robot 1 is in the bridge posture illustrated in (f) of FIG. 5, the force F acts on the robot 1. This causes the robot 1 to naturally begin to fall forward. As a result, the posture of the robot 1 changes to the posture illustrated in (a) of FIG. 6. When the robot 1 changes to this posture, the posture controlling section 10 does not control the servomotors such as the hip joint pitch sections (the right hip joint pitch section 16 and the left hip joint pitch section 17). In other words, the robot 1 naturally begins to fall toward a region in front of the robot 1. Further falling of the robot 1 toward the leg parts (the right leg part 6 and the left leg part 7) causes the projected point. T of the center of gravity of the robot 1 to once again move inside the support polygon R.

Inertia causes the robot 1 to continue falling forward, and the posture of the robot 1 changes from the posture illustrated in (b) of FIG. 6 to the posture illustrated in (c) of FIG. 6. When the robot 1 changes to this posture, both of the arm parts (the right arm part 4 and the left arm part 5) lift up from the ground plane M and are in midair. Both of the foot parts (the right foot part 62 and the left foot part 72) still remain in contact with the ground plane M. As such, the support polygon R is formed by both of the foot parts (the right foot part 62 and the left foot part 72).

Once the robot 1 is in the posture illustrated in (c) of FIG. 6, the posture controlling section 10 causes both of the shoulder pitch sections (the right shoulder pitch section 12 and the left shoulder pitch section 13) to rotate in the negative direction N. This causes both of the arm parts (the right arm part 4 and the left arm part 5) to move toward a region in front of the trunk part 3. Furthermore, the posture controlling section 10 causes both of the hip joint pitch sections (the right hip joint pitch section 16 and the left hip joint pitch section 17) to rotate in the positive direction P. This causes the head part 2, the trunk part 3, and both of the arm parts (the right arm part 4 and the left arm part 5) to move toward a region in front of the robot 1 (so as to cause the trunk part 3 and the like to become upright). As a result, the posture of the robot 1 changes from the posture illustrated in (c) of FIG. 6 to the posture illustrated in (d) of FIG. 6 and then further to the posture illustrated in (e) of FIG. 6.

Once the robot 1 is in the posture illustrated in (e) of FIG. 6, the posture controlling section 10 continues to cause both of the shoulder pitch sections (the right shoulder pitch section 12 and the left shoulder pitch section 13) to rotate in the negative direction N. This causes both of the arm parts (the right arm part 4 and the left arm part 5) to move further toward the region in front of the trunk part 3. This causes the posture of the robot 1 to change from the posture illustrated in (e) of FIG. 6 to the posture illustrated in (f) of FIG. 6. This change of posture causes the projected point T to once again move from a position inside the support polygon R to a position that is outside the support polygon R and near each of the leg parts (the right leg part 6 and the left leg part 7). As a result, the force F once again acts on the robot 1 so as to cause the robot 1 to fall toward a region in front of the trunk part 3. As such, the robot 1 becomes even more likely to fall toward a region in front of the robot 1.

Once the robot 1 is in the posture illustrated in (f) of FIG. 6, the posture controlling section 10 causes both of the shoulder pitch sections (the right shoulder pitch section 12 and the left shoulder pitch section 13) to continue rotating in negative direction N. This causes both of the arm parts (the right arm part 4 and the left arm part 5) to move toward the region in front of the trunk part 3 as the robot 1 continues to fall frontward. As a result, the posture of the robot 1 changes from the posture illustrated in (f) of FIG. 6 to the posture illustrated in (g) of FIG. 6. This change of posture causes both of the foot parts (the right foot part 62 and the left foot part 72) to lift up from the ground plane M and be in midair. Furthermore, a lower portion of the trunk part 3 and upper portions of both of the leg parts (the right leg part 6 and the left leg part 7) come into contact with the ground plane M.

Once the robot 1 is in the posture illustrated in (g) of FIG. 6, the posture controlling section 10 causes both of the shoulder pitch sections (the right shoulder pitch section 12 and the left shoulder pitch section 13) to continue rotating in negative direction N. This causes both of the arm parts (the right arm part 4 and the left arm part 5) to move further toward the region in front of the trunk part 3 as the robot 1 continues to fall frontward. As a result, the posture of the robot 1 changes from the posture illustrated in (g) of FIG. 6 to the posture (prone posture) illustrated in (h) of FIG. 6. With this change of posture, the trunk part 3 of the robot 1 undergoes a large fall toward the ground plane M, and both of the hand parts (the right hand part 43 and the left hand part 53) come into contact with the ground plane M. This causes the support polygon R to be formed by both of the hand parts (the right hand part 43 and the left hand part 53) and both of the foot parts (the right foot part 62 and the left foot part 72). The projected point T once again moves to a position inside the support polygon R.

### Posture Change to Upright Posture

The robot 1 changes its posture from the prone posture illustrated in (h) of FIG. 6 to the upright posture shown in (b) of FIG. 4. The control carried out by the robot 1 during this change is commonly used, and as such a detailed description of such is omitted here. Once the robot 1 takes on the prone posture illustrated in (h) of FIG. 6, it is easy to change that posture to the upright posture (i.e., it is easy for the robot 1 to stand up).

It can be said that the posture controlling section 10 carries out control to sequentially change the posture of the robot 1 in a manner so as to (i) gradually decrease a size of the support polygon R, and then, once the support polygon R has reached a certain size, (ii) gradually increase the size of the support polygon R once again, as illustrated in FIGS. 5 and 6.

### Advantages of Embodiment 1

With the robot 1, it is not necessary to move the ZMP to the soles of the foot parts (the right foot part 62 and the left foot part 72) in order to take on the bridge posture illustrated in (f) of FIG. 5. As such, the robot 1 can take on the bridge posture even in a case where the robot 1 has a simple configuration in which, for example, the arm parts (the right arm part 4 and the left arm part 5) are short or in which no knee joints are provided. In this way, an embodiment of the present invention makes it possible to provide a robot which has a simpler configuration and is capable of a stand-up operation.

### Embodiment 2

In Embodiment 2, a posture controlling section 10 causes a posture of a robot 1 to change from the posture illustrated in (e) of FIG. 5 to the bridge posture illustrated in (f) of FIG. 5. The posture controlling section 10 achieves this by causing leg parts (a right leg part 6 and a left leg part 7) to move behind a trunk part 3 toward the arm parts (a right arm part 4 and a left arm part 5) while maintaining a state of non-contact between (i) respective distal ends (foot parts (a right foot part 62 and a left foot part 72) of the arm parts (the right arm part 4 and (ii) the ground plane M. This makes it possible to change the posture of the robot 1 to the bridge posture illustrated in (f) of FIG. 5 even in a case where the robot 1 has been placed in a place which (i) is not flat, (ii) has a foreign object or protrusion, or (iii) has, on its surface, rubber or some other such body which inhibits sliding.

### Embodiment 3

A functional block (posture controlling section 10) of the robot 1 illustrated in FIG. 2 can be realized by a logic circuit (hardware) provided in an integrated circuit (IC chip) or the like or can be alternatively realized by software as executed by a CPU (provided to the robot 1).

In the latter case, the robot 1 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium.

Examples of the storage medium encompass a non-transitory tangible medium such as a tape, a disk, a card, a semiconductor memory, and a programmable logic circuit. The program can be supplied to the computer via any transmission medium (such as a communication network or a broadcast wave) which allows the program to be transmitted. Note that an embodiment of the present invention can also be achieved in the form of a computer data signal in which the program is embodied via electronic transmission and which is embedded in a carrier wave.

### Software Implementation Example

A functional block (posture controlling section 10) of the robot 1 illustrated in FIG. 2 can be realized by a logic circuit (hardware) provided in an integrated circuit (IC chip) or the like or can be alternatively realized by software as executed by a CPU (provided to the robot 1).

In the latter case, the robot 1 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium.

Examples of the storage medium encompass a non-transitory tangible medium such as a tape, a disk, a card, a semiconductor memory, and a programmable logic circuit. The program can be supplied to the computer via any transmission medium (such as a communication network or a broadcast wave) which allows the program to be transmitted. Note that an embodiment of the present invention can also be achieved in the form of a computer data signal in which the program is embodied via electronic transmission and which is embedded in a carrier wave.

### Recap

A robot in accordance with Aspect 1 of the present invention includes at least: a head part; a trunk part; arm parts; leg parts; and a posture controlling section configured to change a posture of the robot from a first posture to a second posture, the first posture being a posture in which (i) respective front portions of at least the leg parts face vertically upward and (ii) a projected point, which represents a center of gravity of the robot projected onto a plane parallel to a support polygon of the robot, falls inside the support polygon, the second posture being a posture in which the projected point is at a position that is outside the support polygon and near each of the leg parts.

With the above configuration, when the posture of the robot changes from the first posture to the second posture, the projected point representing the center of gravity of the robot moves from a position inside the support polygon to a position that is outside the support polygon and near each of the leg parts of the robot. As a result, a force acts on the robot so as to cause the robot to fall toward the leg parts. This makes it possible to cause the posture of the robot to naturally change from the second posture to a prone posture. Once the robot takes on the prone posture, it is easy for the robot to take on a bipedal standing posture.

When the robot changes its position to the second posture, it is not necessary to move the ZMP of the robot to the bottoms of the leg parts. As such, the robot can take on the second posture even in a case where the robot has a simpler configuration in which, for example, the arm parts are short or in which no knee joints are provided.

In this way, an aspect of the present invention makes it possible to provide a robot which has a simpler configuration and is capable of a stand-up operation.

In Aspect 2 of the present invention, the robot in accordance with Aspect 1 can be arranged such that the second posture is a posture in which a front portion of the trunk part or a front portion of the head part faces vertically upward.

With the above configuration, it is possible to cause the posture of the robot to naturally change from the second posture to the prone posture.

In Aspect 3 of the present invention, the robot in accordance with Aspect 1 or Aspect 2 can be arranged such that: the first posture is a posture in which the robot is sitting; and the posture controlling section is configured to change the posture of the robot from the first posture to the second posture by causing the leg parts to move behind the trunk part toward the arm parts.

The above configuration makes it possible to provide a robot that can stand up from a sitting posture.

In Aspect 4 of the present invention, the robot in accordance with Aspect 3 can be arranged such that the posture controlling section is configured to change the posture of the robot from the first posture to the second posture by causing the leg parts to move while maintaining contact between (i) respective distal ends of the leg parts and (ii) a ground plane on which the robot is placed.

The above configuration makes it possible for the robot to maintain stability while changing to the second posture.

In Aspect 5 of the present invention, the robot in accordance with Aspect 3 can be arranged such that the posture controlling section is configured to change the posture of the robot from the first posture to the second posture by causing the leg parts to move while maintaining a state of non-contact between (i) respective distal ends of the leg parts and (ii) a ground plane on which the robot is placed.

The above configuration makes it possible to change the posture of the robot to the second posture even in a case where the robot has been placed in a place which (i) is not flat, (ii) has a foreign object or protrusion, or (iii) has, on its surface, rubber or some other such body which inhibits sliding.

In Aspect 6 of the present invention, the robot in accordance with any one of Aspects 3 to 5 can be arranged such that the posture controlling section is configured to cause the arm parts to move toward a region in front of the trunk part after the robot has, due to being in the second posture, begun falling toward a region in front of the robot.

The above configuration makes it possible for the robot to take on a prone posture from which the robot can easily stand up.

A method of controlling a robot in accordance with Aspect 7 of the present invention is a method of controlling a robot including at least a head part, a trunk part, arm parts, and leg parts, the method including the step of: controlling the posture of the robot so as to change the posture of the robot from a first posture to a second posture, the first posture being a posture in which (i) respective front portions of at least the leg parts face vertically upward and (ii) a projected point, which represents a center of gravity of the robot projected onto a plane parallel to a support polygon of the robot, falls inside the support polygon, the second posture being a posture in which the projected point is at a position that is outside the support polygon and near each of the leg parts.

The above method makes it possible to provide a robot which has a simpler configuration and is capable of a stand-up operation.

The robot according to the foregoing aspects of the present invention may be realized in the form of a computer. In such a case, the present invention encompasses: a control program for the robot which program causes a computer to operate as each of the sections of the robot so that the robot can be realized in the form of a computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. It is possible to form a new technical feature by combining the technical means disclosed in the respective embodiments.

### REFERENCE SIGNS LIST

1 Robot

2 Head part

3 Trunk part

4 Right arm part

5 Left arm part

6 Right leg part

7 Left leg part

10 Posture controlling section

11a Neck roll section

11b Neck pitch section

11c Neck yaw section

12 Right shoulder pitch section

13 Left shoulder pitch section

14 Right elbow roll section

15 Left elbow roll section

16 Right hip joint pitch section

17 Left hip joint pitch section

18a Right ankle roll section

18b Right ankle pitch section

19a Left ankle roll section

19b Left ankle pitch section

41 Right upper arm part

42 Right forearm part

43 Right hand part

51 Left upper arm part

52 Left forearm part

53 Left hand part

61 Right thigh part

62 Right foot part

71 Left thigh part

72 Left foot part

1. A robot comprising at least:
a head part;
a trunk part;
arm parts;
leg parts; and
a posture controlling section configured to change a posture of the robot from a first posture to a second posture,
the first posture being a posture in which (i) respective front portions of at least the leg parts face vertically upward and (ii) a projected point, which represents a center of gravity of the robot projected onto a plane parallel to a support polygon of the robot, falls inside the support polygon,
the second posture being a posture in which the projected point is at a position that is outside the support polygon and near each of the leg parts.

2. The robot according to claim 1, wherein the second posture is a posture in which a front portion of the trunk part or a front portion of the head part faces vertically upward.

3. The robot according to claim 1, wherein:
the first posture is a posture in which the robot is sitting; and
the posture controlling section is configured to change the posture of the robot from the first posture to the second posture by causing the leg parts to move behind the trunk part toward the arm parts.

4. The robot according to claim 3, wherein the posture controlling section is configured to change the posture of the robot from the first posture to the second posture by causing the leg parts to move while maintaining contact between (i) respective distal ends of the leg parts and (ii) a ground plane on which the robot is placed.

5. The robot according to claim 3, wherein the posture controlling section is configured to change the posture of the robot from the first posture to the second posture by causing the leg parts to move while maintaining a state of non-contact between (i) respective distal ends of the leg parts and (ii) a ground plane on which the robot is placed.

6. The robot according to claim 3, wherein the posture controlling section is configured to cause the arm parts to move toward a region in front of the trunk part after the robot has, due to being in the second posture, begun falling toward a region in front of the robot.

7. A method of controlling a robot including at least a head part, a trunk part, arm pa and leg parts, the method comprising the step of:
controlling the posture of the robot so as to change the posture of the robot from a first posture to a second posture,
the first posture being a posture in which (i) respective front portions of at least the leg parts face vertically upward and (ii) a projected point, which represents a center of gravity of the robot projected onto a plane parallel to a support polygon of the robot, falls inside the support polygon,
the second posture being a posture in which the projected point is at a position that is outside the support polygon and near each of the leg parts.

8. A non-transitory tangible storage medium which stores a program for causing a computer to function as the robot recited in claim 1, the program causing the computer to function as the posture controlling section.
